(19) United States
(12) Patent Application Publication
(10) Pub. No.: US 2009/0182496 A1
(43) Pub. Date: Jul. 16, 2009

(54) Map information delivery server, map information delivery system and method for delivering map information

(75) Inventor: Atsushi Tanabe, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/292,496

(22) Filed: Nov. 20, 2008

(30) Foreign Application Priority Data
Jan. 14, 2008 (JP) 2008-5112

(51) Int. Cl. G01C 21/26

(52) U.S. Cl. 701/200

(57) ABSTRACT

A map information delivery server includes: a memory that receives a travel record of a vehicle transmitted from an in-vehicle communication device of the vehicle, and stores the travel record; an update unit that obtains a new map data from an external information media; an extraction unit that specifies an updated portion of the new map data; and a transmitter that transmits a road data to the in-vehicle communication device of the vehicle. The road data is a part of the updated portion of the new map data, and relates to the travel record of the vehicle. Thus, the server delivers the updated map data without driving on the same road if the vehicle has driven on the road in the past.

### CROSS REFERENCE TO RELATED APPLICATION

This application is based on Japanese Patent Application No. 2008-5112 filed on Jan. 14, 2008, the disclosure of which is incorporated herein by reference.

### FIELD OF THE INVENTION

The present invention relates to a map information delivery server, a map information delivery system and a method for delivering map information to an in-vehicle communication device of a vehicle.

### BACKGROUND OF THE INVENTION

In a map information delivery system described in JP-A-2007-78481, a driving record of a road, on which a vehicle has traveled, is transmitted from an in-vehicle communication device of the vehicle to a map information delivery server, which is an external server. The server searches information about a newly constructed road from an updated database of a map data, the newly constructed road connecting to the road, on which the vehicle has traveled. When the server finds the information about the newly constructed road, the server sends the data of the newly constructed road to the in-vehicle communication device. Thus, it is not necessary to send all of updated map data to the in-vehicle communication device when the map data is updated. Thus, unnecessary data delivery of the map data is limited.

In the map information delivery system, the delivery from the server to the in-vehicle communication device based on the updated map data is performed when the server receives the travel record from the in-vehicle communication device. Further, the delivery is performed only about the travel record, which is received by the server.

Accordingly, when the vehicle had traveled on a road A in the past, the in-vehicle communication device transmitted the travel record of the road A, and the in-vehicle communication device received the map data from the server at that time. If a new road B is constructed to connect to the road A after that, the data of the new road B is not transmitted to the in-vehicle communication device unless the vehicle travels on the road A. Specifically, the in-vehicle communication device receives only the information of the new road at a time when the vehicle travels on the road A.

### SUMMARY OF THE INVENTION

In view of the above-described problem, it is an object of the present disclosure to provide a map data delivery server. It is another object of the present disclosure to provide a map data delivery system. It is further another object of the present disclosure to provide a method for delivering map information to an in-vehicle communication device of a vehicle.

According to a first aspect of the present disclosure, a map information delivery server includes: a memory that receives a travel record of a vehicle transmitted from an in-vehicle communication device of the vehicle, and stores the travel record; an update unit that obtains a new map data from an external information media; an extraction unit that specifies an updated portion of the new map data; and a transmitter that transmits a road data to the in-vehicle communication device of the vehicle. The road data is a part of the updated portion of the new map data, and relates to the travel record of the vehicle.

When the vehicle drove on a certain road in the past, the in-vehicle communication device transmitted the travel record of the certain road. After that, the map data relating to the certain road is updated. The server transmits the part of the updated portion of the new map data without driving on the certain road again.

According to a second aspect of the present disclosure, a map information delivery system includes: the map information delivery server according to the first aspect; and the in-vehicle communication device of the vehicle.

In the above system, the server transmits the part of the updated portion of the new map data without driving on the same road again.

According to a third aspect of the present disclosure, a method for delivering map information to an in-vehicle communication device of a vehicle includes: receiving a travel record of the vehicle transmitted from the in-vehicle communication device of the vehicle, and storing the travel record; obtaining a new map data from an external information media; specifying an updated portion of the new map data by comparing the new map data with an old map data; and transmitting a road data to the in-vehicle communication device of the vehicle at a time when the new map data is obtained. The road data is a part of the updated portion of the new map data, and the road data provides a data of a road, which is a part of a traveling road of the vehicle or connected to the traveling road of the vehicle.

In the above method, the part of the updated portion of the new map data is transmitted without driving on the same road again.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a map information delivery system;

FIG. 2 is a diagram illustrating a block diagram of an in-vehicle navigation device;

FIG. 3 is a diagram illustrating a block diagram of a map information delivery server;

FIG. 4 is a diagram illustrating a communication process between the navigation device and the server; and

FIG. 5 is a diagram illustrating a flowchart of a transmitting process in the server.

### DETAILED DESCRIPTION OF THE PREFERRED EMBODIMENTS

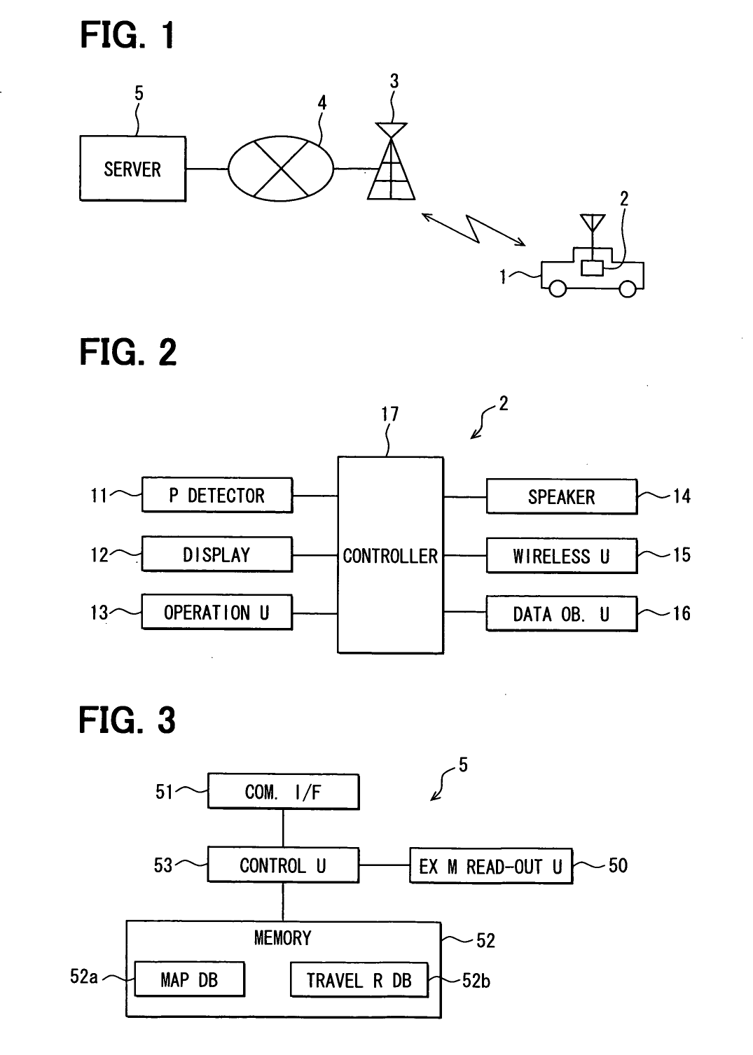

FIG. 1 shows a map information delivery system according to an example embodiment of the present disclosure. The system includes an in-vehicle navigation device 2, a wireless base station 3, a communication network 4 and a map information delivery server 5. The in-vehicle navigation device 2 is mounted on a vehicle 1, which travels on a road. The in-vehicle navigation device 2 communicates with the map information delivery server 5 via the wireless base station 3 and the communication network 4.

The navigation device 2 stores a travel record of the road, on which the vehicle travels. The navigation device 2 sends the stored travel record to the server 5 via the station 3 and the network 4. The server 5 receives the travel record, and compares the received travel record with an updated map data. Then, the server 5 extracts a data of a road relating to the travel record based on the updated map data. The road relating to the travel record includes the road in the travel record and a road connecting to the road in the travel record. The server 5 sends the extracted data of the road to the navigation device 2 via the network 4 and the station 3.

The travel record to be used for extracting the data of the road includes all travel records, which have been received from the navigation device 2 before the server 5 obtains the updated map data. Further, the extraction of the data and the transmission of the data to the navigation device 2 are performed at the time when the map data in the server 5 is updated.

In FIG. 1, one pair of the vehicle 1 and the navigation device 2 is shown. The server 5 communicates with multiple navigation devices 2 in respective vehicles 1 and performs the above process for each navigation device 2, which has substantially the same function as the navigation device 2 shown in FIG. 1.

The operation of the map information delivery system will be explained. FIG. 2 shows the navigation device 2. The navigation device 2 includes a position detector 11, an image display 12, an operation unit 13, a speaker 14, a wireless unit 15, a map data obtaining unit 16 and a control circuit, i.e., a controller 17.

The position detector 11 includes a geomagnetic sensor, a gyroscope, a vehicle speed sensor, a GPS receiver and the like. Based on information from each sensor and receiver, the position detector 11 outputs information about a current position of the vehicle, a driving direction and a vehicle speed of the vehicle to the controller 17.

The display 12 displays an image based on an image signal from the controller 17 so that a user recognizes the information corresponding to the image. The user operates the operation unit 13 so that the operation unit 13 outputs a signal corresponding to the user's operation to the controller 17.

The wireless unit 15 connects to the wireless base station 3 by radio so that the wireless unit 15 communicates with a communication device such as the map information delivery server 5, which is disposed on the network 4. The wireless unit 15 performs various processes such as a frequency converting process, a modulation process, a demodulation process, an amplifying process and the like.

The map data obtaining unit 16 includes a rewritable non-volatile memory such as a HDD. The memory stores a program for the controller 17, a map data for route guidance, the travel record of the vehicle 1 and the like.

The map data includes a road data and a facility data. The road data includes position information about a link of the road, category information of the link, position information about a node of the road, category information of the node, information of a relationship between the link and the node and the like. The facility data includes information about a name of each facility, a location of the facility, a category of the facility and the like. Further, the map data includes its version information.

The controller 17 is a micro computer including a CPU, a RAM, a ROM a I/O element and the like. The CPU reads out the program for operating the navigation device 1 from the ROM or the map data obtaining unit 16, and executes the program. When the CPU executes the program, the CPU further reads out information from an external media read-out unit 50, the RAM, the ROM and the map data obtaining unit 16, and the CPU writes the information in a memory medium such as the RAM and the map data obtaining unit 16. Furthermore, the CPU communicates with the position detector 11, the display 12, the operation unit 13 and the speaker 14.

The controller 17 executes the program so that a map display process, a navigation process, a travel record storage process, a travel record transmission process, a map information update process and the like are performed.

In the map display process, a part of the map data is read out, and the display 12 displays the image of the map corresponding to the part of the map data. The map to be shown on the display 12 is, for example, a map around the current position of the vehicle 1 based on the information from the position detector 11 and a map around a point that is set by the user through the operation unit 13.

In the navigation process, the user sets a destination through the operation unit 13 and the like, and the controller 17 determines an optimum guiding route to the destination based on the map data. The controller 17 informs driving guidance of the vehicle 1 along with the guiding route. The guidance is performed by a map display process and a voice guide process. The map display process is, for example, executed by the display 12 such that a partially enlarged map near a cross section is displayed. The voice guide process is, for example, executed by the speaker 14 such that the speaker 14 announces a voice message for instructing right or left turn along with the guiding route. The travel record storage process, the travel record transmission process and the map information update process will be explained latter.

FIG. 3 shows the server 5. The server 5 includes the external media read-out unit 50, a communication interface 51, a memory 52 and a control unit 53.

The read-out unit 50 reads out data from a detachable record medium such as a DVD medium, a CD medium, a removable hard disk, and a USB memory.

The communication interface 51 electrically connects to the network 4 so that the server 5 communicates with a communication device on the network 4 and a communication element such as the navigation device 2, which is connected to the base station 3 by wireless.

The memory 52 is, for example, a rewritable record medium such as a HDD. The memory 52 stores a map DB 52a and a travel record DB 52b. The map DB 52a stores map data of multiple versions. The travel record DB 52b stores the travel record received from the navigation devices 2.

The map DB 52a preliminary stores at least one map data of a predetermined version. The map data includes its version information.

The control unit 53 includes a CPU, a RAM, a ROM, an I/O element and the like. The CPU executes a program for operating the server 5, which is read out from the memory 52. When the control unit 53 executes the program, the CPU reads out information from the RAM, the ROM and the memory 52, and writes the information in the RAM and the memory 52. Further, the CPU communicates with the communication interface 51, i.e., the CPU sends a signal to and receives a signal from the interface 51.

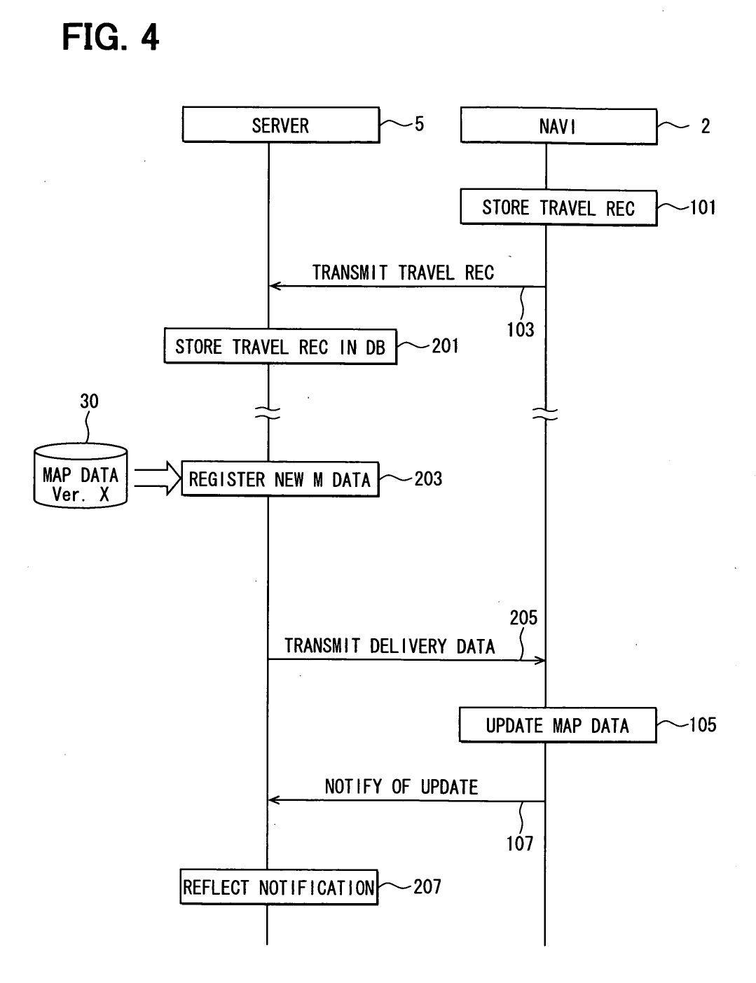

The operation of the navigation device 2 and the server 5 will be explained as follows. FIG. 4 shows a sequence of the communication process between the navigation device 2 and the server 5.

The controller 17 in the navigation device 2 sequentially determines the position of the vehicle 1 based on the information from the position detector 11 when the vehicle 1 runs. Based on the specified position of the vehicle 1 and the map data, the controller 17 determines by a map matching method or the like where the vehicle 1 is located on the link in the map. In Step 101, the controller 17 stores the information about the determined driving road in the map data obtaining unit 16, and the information about the driving road provides the travel record.

The travel record may be stored at every predetermined driving distance or at every predetermined time. Thus, the travel record is repeatedly stored in the map data obtaining unit 16. The contents of the travel record to be store at every interval includes information about a specified link, version information of the map data that is used at a time when the vehicle 1 drives on the link, and ID information about an in-vehicle device of the navigation device 2 for identifying the navigation device 2 from other navigation devices. The ID information of the in-vehicle device is stored in, for example, the ROM of the controller 17.

The information about the determined link includes, for example, a link ID information of the link, on which the vehicle runs, a driving direction on the link, another link ID information of another link that is connected to the link, information about road category of the link, and the road name of the link.

The controller 17 may merge the travel record corresponding to multiple times into one travel record data when the vehicle runs on the same link multiple times. In this case, the information overlapped with each other is cancelled when the travel record is stored in the map data obtaining unit 16.

Alternatively, the controller 17 may merge the travel record at every road name, and store the record in the map data obtaining unit 16. Specifically, even when the first link in the first travel record is different from the second link in the second travel record, and the first link includes the same name of the road as the second link, the first travel record and the second travel record are merged to remove the overlapped information between the first and second travel records. Then, the merged travel record is stored in the map data obtaining unit 16.

When the travel record of multiple times is merged at every link, or when the travel record is merged at every road name, the merged data may include information about the number of driving times corresponding to the link or the road name.

The controller 17 transmits the stored travel record to the server 5 via the wireless unit 15 in Step S103. This transmission may be repeated. Specifically, the controller 17 may transmit the travel record at every time when the controller 17 stores the travel record in the map data obtaining unit 16. Alternatively, the controller 17 may transmit the travel record at every time interval. Alternatively, the controller 17 may transmit the travel record at every predetermined driving distance.

The travel record to be transmitted at each time may include multiple travel records stored from a previous transmission time to a present transmission time. In this case, the travel record to be transmitted at each time is always a newly obtained travel record, so that the controller 17 does not transmit a previously transmitted travel record. Accordingly, the controller 17 does not transmit the same travel record twice so that excess data transmission is limited. Here, the previously transmitted travel record may be deleted or maintained.

The connection between the navigation device 2 and the base station 3 may be disconnected because of specific environmental condition. In this case, the controller 17 holds the travel record until the navigation device 2 is connected to the base station 3 again by wireless. After the navigation device 2 is reconnected to the base station 3, the controller 17 transmits the data.

The control unit 53 in the server 5 receives the information about the travel record via the interface 51. The server 5 stores the received travel record corresponding to the navigation device 2 of the vehicle 1 in the travel record DB 52b in the memory 52 in Step S201. Specifically, the received travel record is stored in a corresponding navigation device region of the travel record DB 52b.

When the received travel record regarding the link or the road name is the same as the travel record of the corresponding navigation device 2 that is already stored in the DB 52b, the server 5 may not store the received travel record in the DB 52b but increase the number of driving times in the travel record by one time. In this case, although the received travel record is not recorded in the DB 52b, the information about the received travel record is practically recorded in the DB 52b. Further, memory capacity of the DB 52b is saved.

The stored travel record is held in the DB 52b. Accordingly, even when a new map data 30 is registered in the server 5, the travel record is held.

After the control unit 53 controls to store the received travel record in the DB 52b, the server 5 receives the new map data 30 having a new version X. Then, the server 5 registers the new map data 30 in Step S203. Here, the new map data 30 may be obtained from another device on the network 4 via the communication interface 51. Alternatively, an external medium storing the new map data 30 therein is set in the server 5 so that the new map data 30 is read out by the external medium read-out unit 50.

The new map data 30 includes version information of the data 30. Further, the data 30 may include an upgrade record of old versions. The upgrade record is information showing addition, change and/or deletion of a segment in the new map data 30 compared with the old version map data.

When the new map data 30 is registered in the DB 52a, the control unit 53 transmits a part of the new map data 30 to the navigation device 2 in Step S205. Thus, the register of the new map data 30 functions as a trigger of transmission of the new map data 30.

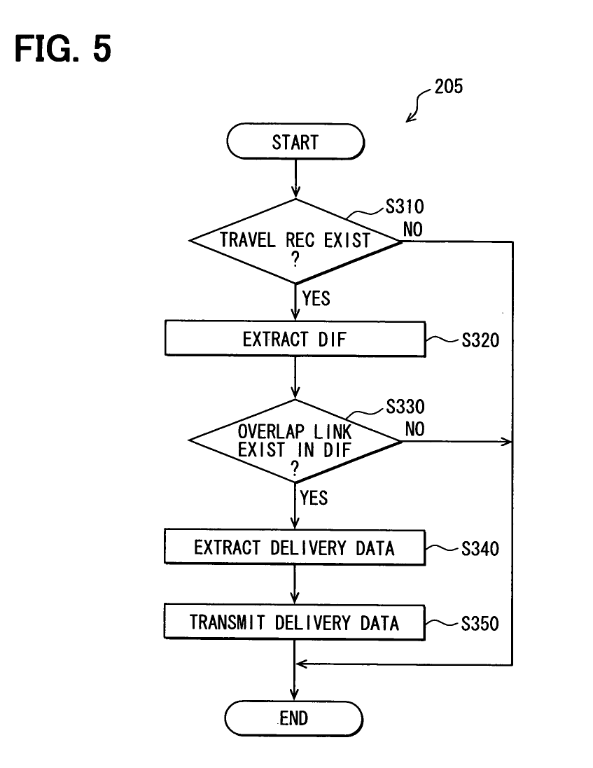

FIG. 5 shows a flowchart of Step S205. In Step S310, the control unit 53 determines whether the travel record is stored in the travel record DB 52b. When the travel record is not stored in the travel record DB 52b, the new map data 30 is not transmitted, and Step S205 is completed.

When the travel record is stored in the travel record DB 52b, difference between the new map data 30 and the old map data is specified with regard to all of the travel records stored in the server 5 in Step S320. The old map data has been stored in the server 5 before the server updates the map data. The difference provides the information about an updated portion of the new map data 30, and thereby, the difference shows what kind of change is performed between the new map data 30 and the old map data.

Specifically, the control unit 53 specifies the version information in each travel record, which is stored in the travel record DB 52b. Thus, the control unit 53 specifies all of the version information in respective travel records. Here, the version information is recorded in the travel record. The control unit 53 specifies the map data corresponding to the specified version information with regard to the travel record. The control unit 53 reads out the map data corresponding to the specified version information from the map DB 52a. Then, the control unit 53 compares the new map data 30 with the read-out map data, so that the control unit 53 specifies, i.e., extracts the difference between the new map data 30 and the old map data. The new map data 30 corresponds to new version information.

When the new map data 30 includes update history, i.e., update record from old versions, the control unit 53 may extract the difference between the new map data 30 and the old map data based on the update record.

In Step S330, the control unit 53 compares the difference in the specified map data with a corresponding travel record so that the control unit 53 determines whether the link in the travel record and relating links connecting to the link are overlapped with the link in the difference. When the link in the travel record is overlapped with the link in the difference, the link is defined as an overlapped link. The control unit 53 verifies all travel records stored in the server 5. Thus, the control unit 53 determines whether the road information in the difference coincides with the road information in the travel record DB 52b. When the control unit 53 determines that all travel records do not include the overlapped link, the new map data 30 is not transmitted, and Step S205 is completed. When the control unit 53 determines that at least one of the travel records includes the overlapped link, it proceeds to Step S340.

In Step S340, a delivery data is extracted from the new map data with regard to the at least one of the travel records including the overlapped link. Specifically, in each travel record including the overlapped link, the data about the overlapped link corresponding to the travel record is extracted from the new map data 30, and this overlapped link data is specified as the delivery data for the travel record. Thus, the delivery data is extracted in accordance with priority.

In Step S350, the delivery data is transmitted in an extracting order. The transmission destination of the delivery data is specified based on the ID information about the in-vehicle device of the navigation device 2, the ID information which is in the travel record used for extracting the delivery data. Further, the delivery data includes version information of the new map data 30. Thus, based on the travel record received before the new map data 30 is registered, the new map data 30 relating to the link, on which the vehicle 1 has driven, is delivered to the navigation device 2 of the vehicle 1.

Here, the extracting order in Step S340 depends on the priority of the travel record for using the extraction. The priority of the travel record depends on the driving times. Specifically, as the driving times in the travel record is higher, the priority of the travel record becomes high. When the record information increases, the amount of the delivery data also increases. By setting the priority, the update information about the link having high priority is delivered preferentially. When the link has the high priority, the vehicle runs on the link frequently.

Alternatively, only the travel record having the priority equal to or higher than a predetermined value may be used for the extraction, and the travel record having the priority lower than the predetermined value may not be used for the extraction. For example, only the travel record having the driving times equal to or larger than a predetermined times, for example, three times, is used for the extraction. Thus, the updated information about the link having the high priority is surely delivered. On the other hand, the updated information about the link having the low priority is not delivered. Thus, the communication traffic is reduced with holding map information delivery.

The controller 17 in the navigation device 2 receives the map data via the wireless unit 15, the map data being delivered from the delivery server 5 and corresponding to the overlapped link data in the new map data 30. Then, the received map data is reflected to the map data in the map data obtaining unit 16 (Step S105). Thus, the map data in the map data obtaining unit 16 is updated.

Here, a part of the received data may be reflected to the map data in the map data obtaining unit 16, the part of the received data having priority equal to higher than a predetermined level. In this case, the other part of the received data having the priority lower than the predetermined level may be deleted. The priority is determined as follows. In each overlapped link data, the travel record in the map data obtaining unit 16 corresponding to the overlapped link data is specified. As the number of driving times in the specified travel record is large, the priority becomes high.

The controller 17 rewrites the version information of the map data in the travel record stored in the map data obtaining unit 16 to a new version information in the new map data 30. The version information of the new map data 30 is read out from the received map data.

After the controller 17 provides to reflect the received map data to the map data in the map data obtaining unit 16, the controller 17 transmits notification of completion of map data update to the server 5 in Step S107. The notification of the update includes the ID information about an in-vehicle device of the navigation device 2.

When the control unit 53 in the server 5 receives the notification of the update, the control unit 53 reflects the notification to the memory 52 in Step S207. Specifically, the control unit 53 specifies a source host of the notification of the update based on the ID information in the notification of the update. The control unit 53 rewrites the mad version information in the travel record of the specified source host in the travel record DB 52b with the map version information of the new map data 30.

Thus, the map version information of the map data in the navigation device 2 is consistent with the map version information in the travel record DB 52b. Accordingly, the server 5 does not extract the updated data in the navigation device 2 again. The server 5 does not transmit excess data, i.e., unnecessary data to the navigation device 2.

The server 5 continues to store the travel record received from the navigation device 2 after the server 5 has received the new map data 30. The server 5 transmits the map data of the link to the navigation device 2, the map data of the link relating to the travel record stored in the server 5 and included in the updated data of the new map data 30.

Accordingly, the vehicle 1 had driven on a certain road in the past, and the navigation device 2 transmitted the travel record to the server 5. After that, when the map data relating to the certain road is updated, the map data relating to the certain road is updated without driving on the same certain road again.

The server 5 transmits the data to the navigation device 2 at a time when the server 5 obtains the new map data, the data relating to the driving road in the travel record, which has been stored in the server 5 before the server 5 obtains the new map data 30, and the data included in the specified updated data.

Thus, the map data delivery at a time when the new map data is obtained is performed effectively and efficiently based on the new map data and the travel record, which has been recorded before the new map data is obtained.

When the traveling record relating to the updated data includes multiple driving roads, the server 5 transmits the map data relating to the driving road having high priority to the navigation device 2. The map data having the high priority corresponds to the map data, number of driving times of which is large. Thus, the map data having large necessity is prioritized and delivered, so that efficiency of the map information delivery is improved.

(Modifications)

In the above embodiment, the navigation device 2 provides the in-vehicle communication device. Other devices that store a map data and receive a new map data from the server 5 to update the map data may provide the in-vehicle communication device.

The update portion of the map data is delivered at a time when the server 5 registers the new map data 30 so that the registration of the map data 30 provides a trigger of the delivery. Alternatively, the update portion of the map data may be delivered at periodic intervals. In this case, during a certain interval, the registration of the new map data 30 is performed.

Each of the controller 17 and the control unit 53 executes a program so that steps shown in FIGS. 4 and 5 are performed. Alternatively, each step may be performed by a structural unit, i.e., a hard ware such as a programmable FPGA (field programmable gate array).

The above disclosure has the following aspects.

According to a first aspect of the present disclosure, a map information delivery server includes: a memory that receives a travel record of a vehicle transmitted from an in-vehicle communication device of the vehicle, and stores the travel record; an update unit that obtains a new map data from an external information media; an extraction unit that specifies an updated portion of the new map data; and a transmitter that transmits a road data to the in-vehicle communication device of the vehicle. The road data is a part of the updated portion of the new map data, and relates to the travel record of the vehicle.

When the vehicle drove on a certain road in the past, the in-vehicle communication device transmitted the travel record of the certain road. After that, the map data relating to the certain road is updated. The server transmits the part of the updated portion of the new map data without driving on the certain road again.

Alternatively, the road data may provide a data of a road, which is a part of a traveling road of the vehicle or connected to the traveling road of the vehicle. The memory stores a map data, and the extraction unit specifies the updated portion by comparing the new map data with the map data stored in the memory. In this case, the map data delivery is effectively performed.

Alternatively, the transmitter may transmit the road data to the in-vehicle communication device at a time when the update unit obtains the new map data.

Alternatively, when the road data includes a plurality of road data portions, each of which relates to the travel record, the transmitter may transmit a road data portion having a large number of driving times by priority. Further, the server may further include a prioritization unit that prioritizes the plurality of road data portions in such a manner that a first road data portion having the first number of driving times is prioritized over a second road data portion having the second number of driving times, wherein the first number is larger than the second number.

According to a second aspect of the present disclosure, a map information delivery system includes: the map information delivery server according to the first aspect; and the in-vehicle communication device of the vehicle.

In the above system, the server transmits the part of the updated portion of the new map data without driving on the same road again.

According to a third aspect of the present disclosure, a method for delivering map information to an in-vehicle communication device of a vehicle includes: receiving a travel record of the vehicle transmitted from the in-vehicle communication device of the vehicle, and storing the travel record; obtaining a new map data from an external information media; specifying an updated portion of the new map data by comparing the new map data with an old map data; and transmitting a road data to the in-vehicle communication device of the vehicle at a time when the new map data is obtained. The road data is a part of the updated portion of the new map data, and the road data provides a data of a road, which is a part of a traveling road of the vehicle or connected to the traveling road of the vehicle.

In the above method, the part of the updated portion of the new map data is transmitted without driving on the same road again.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A map information delivery server comprising:
a memory that receives a travel record of a vehicle transmitted from an in-vehicle communication device of the vehicle, and stores the travel record;
an update unit that obtains a new map data from an external information media;
an extraction unit that specifies an updated portion of the new map data; and
a transmitter that transmits a road data to the in-vehicle communication device of the vehicle,
wherein the road data is a part of the updated portion of the new map data, and relates to the travel record of the vehicle.

2. The server according to claim 1,
wherein the road data provides a data of a road, which is a part of a traveling road of the vehicle or connected to the traveling road of the vehicle,
wherein the memory stores a map data, and
wherein the extraction unit specifies the updated portion by comparing the new map data with the map data stored in the memory.

3. The server according to claim 1,
wherein the transmitter transmits the road data to the in-vehicle communication device at a time when the update unit obtains the new map data.

4. The server according to claim 1,
wherein, when the road data includes a plurality of road data portions, each of which relates to the travel record, the transmitter transmits a road data portion having a large number of driving times by priority.

5. The server according to claim 4, further comprising:
a prioritization unit that prioritizes the plurality of road data portions in such a manner that a first road data portion having the first number of driving times is prioritized over a second road data portion having the second number of driving times, wherein the first number is larger than the second number.

6. A map information delivery system comprising:
the map information delivery server according to claim 1; and
the in-vehicle communication device of the vehicle.

7. A method for delivering map information to an in-vehicle communication device of a vehicle comprising:
receiving a travel record of the vehicle transmitted from the in-vehicle communication device of the vehicle, and storing the travel record;
obtaining a new map data from an external information media;
specifying an updated portion of the new map data by comparing the new map data with an old map data; and
transmitting a road data to the in-vehicle communication device of the vehicle at a time when the new map data is obtained,
wherein the road data is a part of the updated portion of the new map data, and
wherein the road data provides a data of a road, which is a part of a traveling road of the vehicle or connected to the traveling road of the vehicle.
